(19) United States
(12) Patent Application Publication
(10) Pub. No.: US 2026/0116188 A1
(43) Pub. Date: Apr. 30, 2026

(54) CONTROL APPARATUS AND METHOD FOR CONTROLLING A VEHICLE

(71) Applicants: HYUNDAI MOTOR COMPANY, Seoul (KR); KIA CORPORATION, Seoul (KR)

(72) Inventors: Jin Kwon KIM, Gyeonggi-do (KR); Na Eun YANG, Gyeonggi-do (KR); Seung Geon MOON, Gyeonggi-do (KR); Yoo Suk KIM, Gyeonggi-do (KR); Heung Seok CHAE, Gyeonggi-do (KR); Jung Woo HAN, Gyeonggi-do (KR); Woo Joong KIM, Gyeonggi-do (KR); Su Jung YOO, Gyeonggi-do (KR); Ji Chang KIM, Gyeonggi-do (KR)

(73) Assignees: HYUNDAI MOTOR COMPANY, Seoul (KR); KIA CORPORATION, Seoul (KR)

(21) Appl. No.: 19/359,009

(22) Filed: Oct. 15, 2025

(30) Foreign Application Priority Data
Oct. 25, 2024 (KR) 10-2024-0147649

(51) Int. Cl. B60K 35/28; B60W 50/00; B60W 50/14

(52) U.S. Cl. CPC B60K 35/28; B60W 50/14; B60K 2360/1868; B60W 2050/0083; B60W 2050/146

(57) ABSTRACT

A control device and method for displaying a virtual driving route are provided. A control device according to an embodiment of the present disclosure includes a display and a processor configured to generate an expected route for at least one object around the vehicle, set a driving control condition of the vehicle corresponding to the expected route, and control the display to display at least one of a virtual driving route satisfying the driving control condition of the vehicle and the expected route of the object through the display.

### CROSS-REFERENCE TO RELATED APPLICATION

This application claims priority to and the benefit of Korean Patent Application No. 10-2024-0147649, filed on Oct. 25, 2024, the disclosure of which is incorporated herein by reference in its entirety.

### BACKGROUND

### 1. Field of the Disclosure

Various embodiments of the present disclosure relate to technologies for displaying a vehicle and an object in relation to autonomous driving.

### 2. Discussion of Related Art

In recent years, technologies for controlling the driving of vehicles through autonomous driving or vehicle assistance functions are being introduced in the vehicles.

In a driving control process by such a vehicle system, since it is difficult for a driver to predict how a vehicle will be driven, there is a need for visual guidance related to driving control through a display or the like.

Currently, technologies for giving guide to parts of an autonomous driving process by the vehicle system to drivers in relation to autonomous driving have been disclosed, but there are limitations to drivers' recognition or anticipation of specific driving situations to be controlled.

### SUMMARY OF THE DISCLOSURE

The present disclosure has been made to solve the aforementioned problems, and is directed to virtually displaying an expected route of a surrounding object and a driving route of a vehicle specifically.

Problems to be solved by the present disclosure are not limited to those mentioned above, and other problems not mentioned will be clearly understood by those of ordinary skill in the art from the following description.

According to an aspect of the present disclosure, there is provided a control device including a display and a processor configured to generate an expected route for at least one object around a vehicle, set a driving control condition of the vehicle corresponding to the expected route, and control the display to display at least one of a virtual driving route satisfying the driving control condition of the vehicle and the expected route of the object.

In some embodiments, the processor may select a first virtual driving route among a plurality of virtual driving routes that satisfy the driving control condition of the vehicle and control the display to display the selected first virtual driving route.

In some embodiments, the processor may further control the display to display a second virtual driving route excluding the first virtual driving route among the plurality of virtual driving routes.

In some embodiments, the processor may control the display to display the first virtual driving route and the second virtual driving route to be distinguished from each other.

In some embodiments, the processor may control the display to display the first virtual driving route when a control amount corresponding to the first virtual driving route differs from a control amount corresponding to at least one of the plurality of virtual driving routes by a predetermined value or more.

In some embodiments, the processor may display the virtual driving route when a control execution time point corresponding to the virtual driving route is after a predetermined time from a current time point

In some embodiments, the processor may control the display to display the virtual driving route in at least one of the following cases: when a longitudinal control amount corresponding to the virtual driving route is equal to or greater than a predetermined value; and when a lateral control amount corresponding to the virtual driving route is equal to or greater than a predetermined value.

In some embodiments, the processor may be configured to control the display to display the first virtual driving route based on a time point at which a difference between a control amount corresponding to the first virtual driving route and a control amount corresponding to at least one of the plurality of virtual driving routes satisfying the driving control condition of the vehicle reaches or exceeds a predetermined value and end the display of the first virtual driving route when the difference between the control amounts is less than the predetermined value.

In some embodiments, the processor may select the first virtual driving route based on a preference of a vehicle user.

In some embodiments, the processor may be configured to further control the display to display contents related to a current situation through the display, and control the display to display at least one of the expected route of the surrounding object and the virtual driving route of the vehicle to be distinguished from the contents related to the current situation.

According to another aspect of the present disclosure, there is provided a method of displaying a driving route of a vehicle including a display, including generating an expected route for at least one object around the vehicle, setting a traveling control condition of the vehicle corresponding to the expected route, and controlling the display to display at least one of a virtual driving route satisfying the traveling control condition of the vehicle and the expected route of the object through the display.

In some embodiments, the method may further include selecting a first virtual driving route among a plurality of virtual driving routes that satisfy the driving control condition of the vehicle and displaying the selected first virtual driving route through the display.

In some embodiments, the method may further include further displaying a second virtual driving route excluding the first virtual driving route among the plurality of virtual driving routes, through the display.

In some embodiments, in the method, the first virtual driving route and the second virtual driving route may be displayed to be distinguished from each other.

In some embodiments, in the method, the first virtual driving route may be displayed when a control amount corresponding to the first virtual driving route differs from a control amount corresponding to at least one of the plurality of virtual driving routes by a predetermined value or more.

In some embodiments, in the method, the virtual driving route may be displayed when a control execution time point corresponding to the virtual driving route is after a predetermined time from a current time point

In some embodiments, in the method, the virtual driving route may be displayed in at least one of the following cases: when a longitudinal control amount corresponding to the virtual driving route is equal to or greater than a predetermined value; and when a lateral control amount corresponding to the virtual driving route is equal to or greater than a predetermined value.

In some embodiments, in the method, the first virtual driving route may be displayed based on a time point at which a difference between a control amount corresponding to the first virtual driving route and a control amount corresponding to at least one of the plurality of virtual driving routes satisfying the driving control condition of the vehicle reaches or exceeds a predetermined value, and the display of the first virtual driving route may be ended when the difference between the control amounts is less than the predetermined value.

In some embodiments, in the selecting of the first virtual driving route, the first virtual driving route may be selected based on a preference of a vehicle user.

In some embodiments, the method may further include displaying contents related to a current situation through the display, and at least one of the expected route of the surrounding object and the virtual driving route of the vehicle may be displayed to be distinguished from the contents related to the current situation.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a configuration diagram of a vehicle including a control device according to an embodiment;

FIG. 2 is a flowchart of operations of generating and displaying a virtual driving route according to an embodiment;

FIG. 3 is a flowchart of operations of generating an expected route of a surrounding object according to the embodiment;

FIG. 4 is a flowchart of operations of determining a corresponding control condition of the vehicle according to the embodiment;

FIG. 5 is a flowchart of operations of setting a first virtual driving route according to the embodiment;

FIG. 6 is a flowchart of operations of determining display of the first virtual driving route according to the embodiment;

FIG. 7 is a flowchart of operations of determining display of a first virtual driving route according to another embodiment; and

FIGS. 8 to 11 are exemplary views of virtual driving routes displayed according to various embodiments.

### DETAILED DESCRIPTION OF EXEMPLARY EMBODIMENTS

Hereinafter, preferred embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Further, unless specifically defined and described, terms used in the embodiments of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the embodiments of the present disclosure are for the purpose of describing the embodiments only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C.

In addition, in describing a component of embodiments of the present disclosure, terms such as first, second, A, B, (a), (b), etc., may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

In the various flowcharts of the present document, at least some of operations may be omitted or their order may be changed, and at least some of the various embodiments of the present document may be performed at specific points in each operation of the flowchart. Various flowcharts of the present document may be performed by at least one of a control device 100, a processor 130, a vehicle 1, a control unit, or a computer program.

Hereinafter, embodiments will be described in detail with reference to the accompanying drawings, but identical or corresponding components are denoted by the same reference numerals regardless of figure numbers, and redundant descriptions thereof will be omitted.

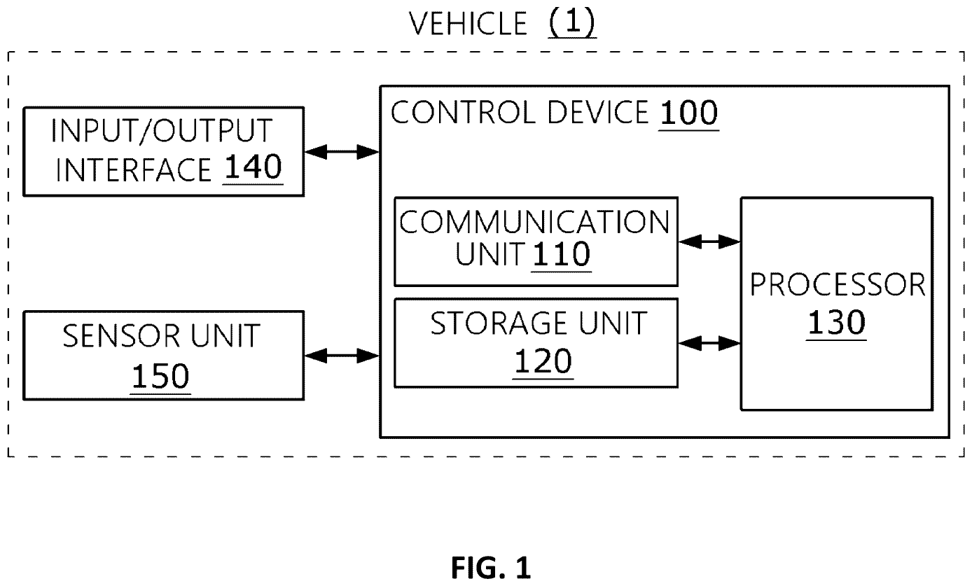

FIG. 1 is a configuration diagram of a vehicle 1 including a control device 100 according to an embodiment.

The vehicle 1 may include the control device 100, a communication unit 110, a storage unit 120, a processor 130, an input/output interface 140, and a sensor unit 150. Each of the components in FIG. 1 may be implemented inside the vehicle.

The control device 100 is a device or program that generates an expected route of a surrounding object, sets a driving control condition of the vehicle 1 corresponding to the expected route of the object, and controls a display to display a virtual driving route of the vehicle 1 that satisfies the driving control condition. The control device 100 may be formed integrally with internal components of the vehicle, or may be implemented as a separate device and connected to the internal components of the vehicle by a separate connecting device. The control device 100 is illustrated as including the communication unit 110, the storage unit 120, and the processor 130, but may also be configured to include other components of the vehicle 1 (e.g., the input/output interface 140, the sensor unit 150, and the like). In some embodiments, the control device 100 may be a hardware device implemented by various electronic circuits (e.g., computer, microprocessor, CPU, ASIC, circuitry, logic circuits, etc.). The control device 100 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The communication unit 110 may communicate with a user terminal, another vehicle, or an external server. The communication unit 110 may perform short range communication, global positioning system (GPS) signal reception, vehicle-to-everything (V2X) communication, optical communication, broadcast transmission and reception, and intelligent transport systems (ITS) communication functions. The communication unit 110 may support short range communication using at least one of Bluetooth, radio frequency identification (RFID), Infrared Data Association (IrDA), ultra wideband (UWB), ZigBee, near field communication (NFC), Wireless-Fidelity (Wi-Fi), Wi-Fi Direct, and wireless Universal Serial Bus (wireless USB) technologies.

The storage unit 120 may store data related to the expected route of the object, the driving control condition corresponding to the expected route, and at least one virtual driving route. The storage unit 120 may include a memory. The storage unit 120 may be provided inside the processor 130 or the control device 100, or may be a separate memory itself. The storage unit 120 may be constituted by a combination of a non-volatile memory such as a hard disk drive, flash memory, electrically erasable programmable read-only memory (EEPROM), static RAM (SRAM), ferro-electric RAM (FRAM), phase-change RAM (PRAM), magnetic RAM (MRAM), or the like, and/or a volatile memory such as a dynamic random access memory (DRAM), synchronous dynamic random access memory (SDRAM), double date rate-SDRAM (DDR-SDRAM), and the like.

The processor 130 may be electrically or operatively connected to the communication unit 110, the storage unit 120, the input/output interface 140, the sensor unit 150, and various internal components of the vehicle 1, and may control each component, and may be an electric circuit that executes software commands, thereby performing various data processing and calculations described below.

The processor 130 may process a signal transmitted between each component of the vehicle 1, and may perform overall control so that each component may normally perform its function. The processor 130 may be implemented in the form of hardware, in the form of software, or in the form of a combination of hardware and software. In addition, the control device 100 may include at least one processor 130.

The input/output interface 140 may include an input unit for receiving a control command from the user and an output unit for outputting an operation state, result, and the like, of the control device 100. Here, the input unit may include physical keys (e.g., physical buttons) and soft keys implemented on a touch display.

The output unit may include a display, and may further include a voice output device such as a speaker, and a haptic module that generates vibration. In this case, when a touch sensor such as a touch film, a touch sheet, a touch pad, or the like, is provided on the display, the display may operate as a touch screen, and may be implemented in a form in which the input unit and the output unit are integrated.

The input/output interface 140 may be implemented as a physical button, a display, a head-up display (HUD), a cluster, an audio video navigation (AVN), a human machine interface (HMI), a user setting menu (USM), or the like. In addition, the display may be included in a rear view mirror or a side mirror.

For example, the user may request a display related to the virtual driving route through a physical button of the cluster or a display of the AVN as an input device. In addition, the vehicle 1 may receive input or output a screen through a display on a console positioned in a second or third row of the vehicle, or through a display of an application implemented on a user terminal.

The sensor unit 150 may include at least one of a radio detection and ranging (RADAR) sensor, a light imaging detection and ranging (LIDAR) sensor, a fingerprint recognition sensor, a retina recognition sensor, an iris recognition sensor, a camera, a steering wheel grip sensor, a pressure sensor, a position sensor (e.g., GPS and the like), an ultrasonic sensor, a heart rate sensor, a light sensor, a pressure-sensitive sensor, a motion sensor, a seating sensor, or an infrared sensor. The camera may include an exterior camera for monitoring the exterior of the vehicle and an interior camera for detecting an object, such as a driver, inside the vehicle.

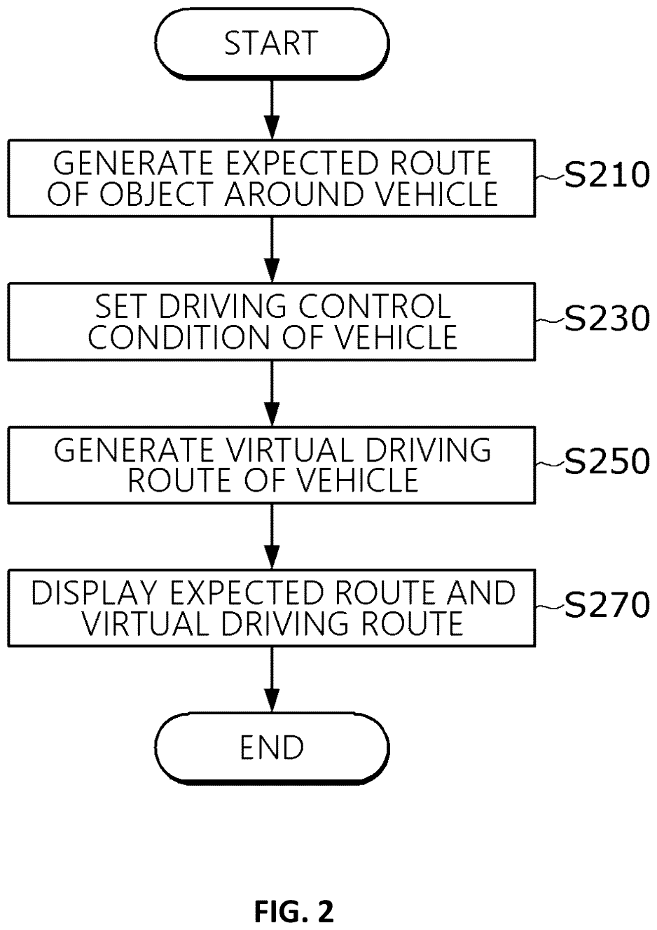

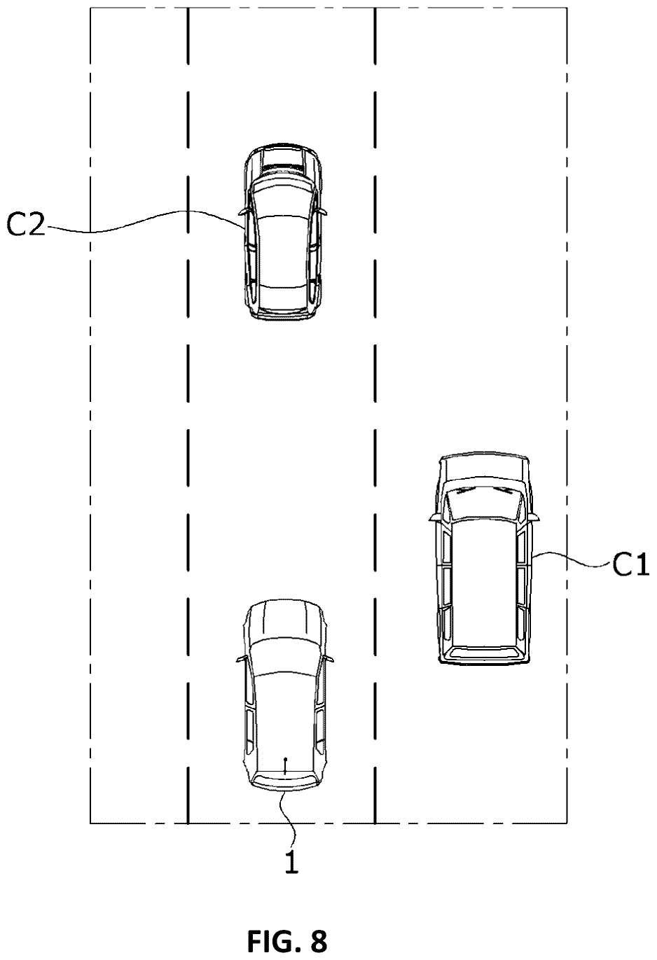

Hereinafter, the contents of generating and displaying a virtual driving route will be described with reference to FIGS. 2 to 7. In FIGS. 2 to 7, a subject of operations is described based on the processor 130, but the operations may be controlled based on instructions set to control the control device 100, the vehicle 1, or the processor 130. For the description of FIGS. 2 to 7, reference to the drawings of FIGS. 8 to 11 will be made. FIGS. 8 to 11 are exemplary views of virtual driving routes displayed according to various embodiments.

FIG. 2 is a flowchart of operations of generating and displaying a virtual driving route according to an embodiment.

The processor 130 may generate an expected route of an object around the vehicle (S210).

Specifically, the processor 130 may detect an object within a predetermined distance from the vehicle 1. The processor 130 may recognize and confirm an object in a region adjacent to the vehicle 1 through the sensor unit 150. The object may include an object such as another vehicle, a bicycle, or a personal mobility device, in the region adjacent to the vehicle 1. In addition, the object may include a person, such as a pedestrian. For example, in FIG. 8, the vehicle 1 may detect surrounding vehicles C1 and C2 as objects. For example, the processor 130 may detect a first object C1 and a second object C2 around the vehicle 1.

The processor 130 may generate an expected route for the detected object. The expected route may be a virtual driving route predicted based on motion information about the object (e.g., a position, heading angle, speed, acceleration, and the like), map information (e.g., lane information, stop lines, crosswalks, and the like), turn signals, and other traffic signals.

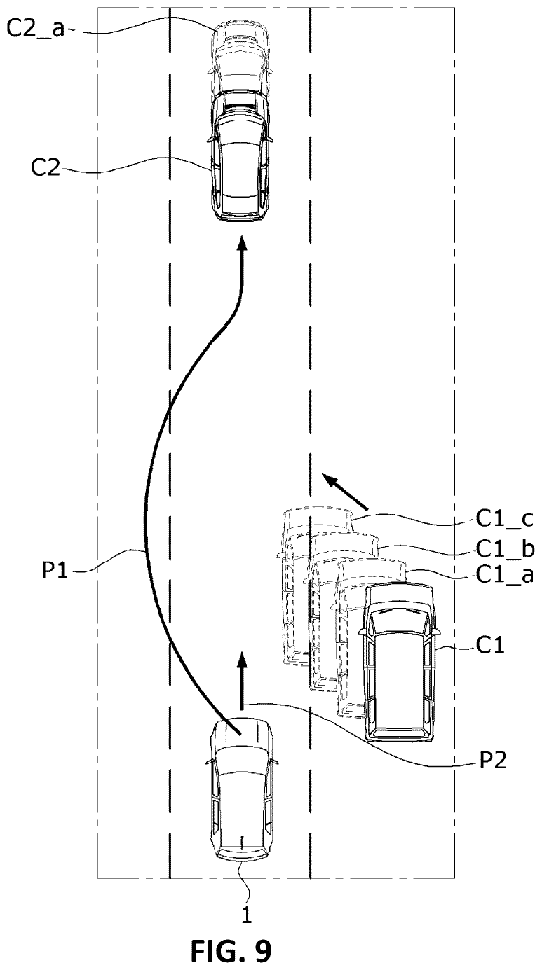

For example, referring to FIG. 9, in a state of traveling in a lane next to a vehicle 1, the first object C1 attempts to change the lane to the same lane as the vehicle 1. Accordingly, the processor 130 may generate an expected route of the first object C1. As an example of generating the expected route, the processor 130 may generate a plurality of virtual objects C1_a, C1_b, and C1_c and display the expected route through the flow of the plurality of virtual objects C1_a, C1_b, and C1_c. In this case, a direction in which the object C1 moves may be additionally indicated using an indicator such as an arrow.

In FIG. 9, the second object C2 is traveling in the same lane as the vehicle 1, and only a longitudinal route thereof is predicted without leaving the lane. The processor 130 may generate an expected route of the second object C2 through a virtual object C2_a.

Meanwhile, when the processor 130 generates an expected route of an object, the processor 130 may generate an expected route for as much time as preset predetermined time (e.g., 5 seconds) based on a specific time point (e.g., a time point at which the object is detected).

Next, the processor 130 may set a driving control condition of the vehicle to correspond to the generated expected route (S230). For example, the processor 130 may set the driving control condition such as whether to overtake, follow, or avoid a specific object, or the like.

In this case, the processor 130 may set a driving control condition corresponding to each recognized object.

For example, referring to FIG. 9, by considering expected routes of the first object C1 and the second object C2, the processor 130 may set a driving control condition so that the vehicle 1 avoids the first object C1 scheduled to cut in and follows the second object C2, which is a preceding vehicle. The driving control condition may be a driving control condition corresponding to a route P1.

In addition, as another driving control condition, the processor 130 may set the driving control condition so that the vehicle 1 does not avoid the first object C1 scheduled to cut in, but follows the second object C2. The driving control condition may be a driving control condition corresponding to a route P2.

The routes P1 and P2 in the above description are expressed to describe the setting of the driving control conditions, but when the processor 130 sets or generates the driving control condition according to the expected routes of the objects, the processor 130 may generate the routes P1 and P2 as UI items and display the UI items later.

Next, the processor 130 may generate a virtual driving route of the vehicle 1 (S250). The virtual driving route of the vehicle 1 may be set to satisfy the driving control condition of the vehicle 1. For example, the processor 130 may generate at least one driving route satisfying the driving control condition.

In one embodiment, the virtual driving route may include a first virtual driving route. The first virtual driving route may refer to an optimal driving route along which the vehicle 1 is allowed to travel corresponding to the expected route of the object. The first virtual driving route may be a virtual driving route extracted based on a user preference. The first virtual driving route may be generated to correspond to, for example, the route P1 in FIG. 9.

In one embodiment, the virtual driving route may include a second virtual driving route. The second virtual driving route may be any one of driving routes excluding the first virtual driving route among the plurality of generated virtual driving routes. For example, the second virtual driving route may be a driving route having user preference scoring after the first virtual driving route. For example, the second virtual driving route may be generated to correspond to the route P2 in FIG. 9.

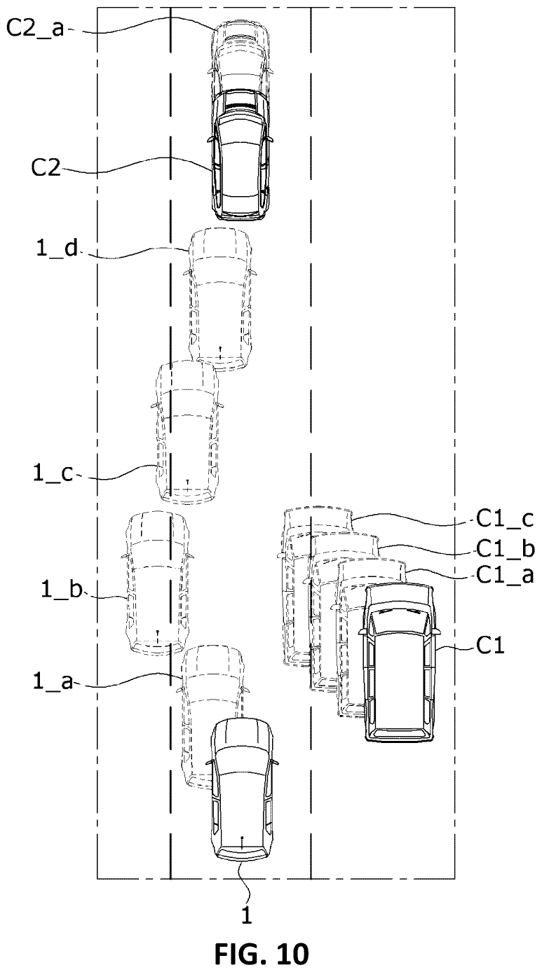

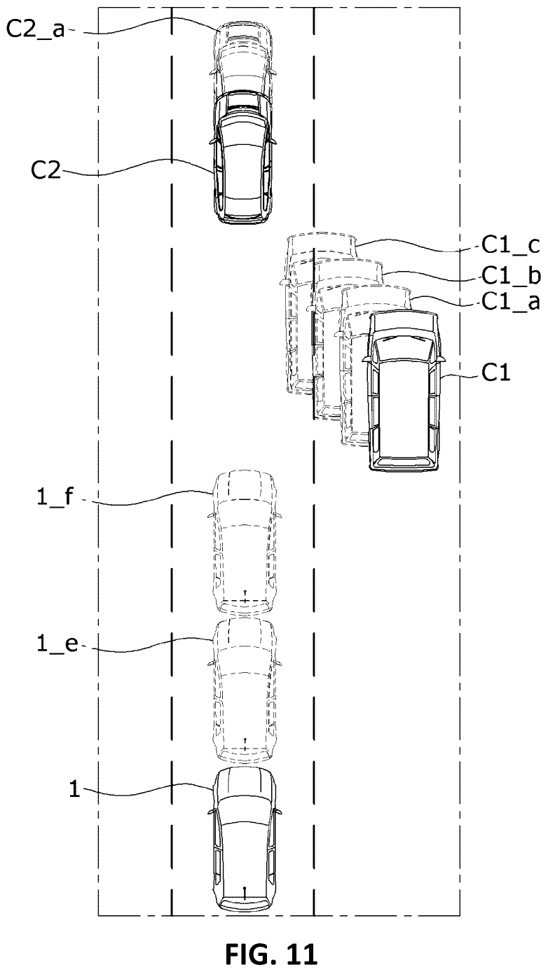

Next, the processor 130 may display the expected route of the object and the virtual driving route of the vehicle 1 (S270). For example, as illustrated in FIGS. 10 and 11, the processor 130 may display the expected route of the object and the virtual driving route of the vehicle 1 through the input/output interface 140 such as the display.

For example, in FIG. 10, the expected routes of the first object C1 and the second object C2 and the virtual driving route of the vehicle 1 are displayed. In FIG. 10, the first virtual driving route of the vehicle 1 is illustrated. That is, among the virtual driving routes of the vehicle 1 satisfying the driving control condition for each of the objects C1 and C2, when considering the user preference as illustrated in FIG. 10, a route for avoiding the first object C1 and following the second object C2 is selected as the first virtual driving route.

The expected route of the first object C1 is displayed through the first object C1 at a current time point and the virtual objects C1_a, C1_b, and C1_c that represent expected locations at given times in the future. The expected route of the second object C2 is also displayed through the second object C2 at the current time point and the virtual object C2_a that represents an expected location at a given time in the future.

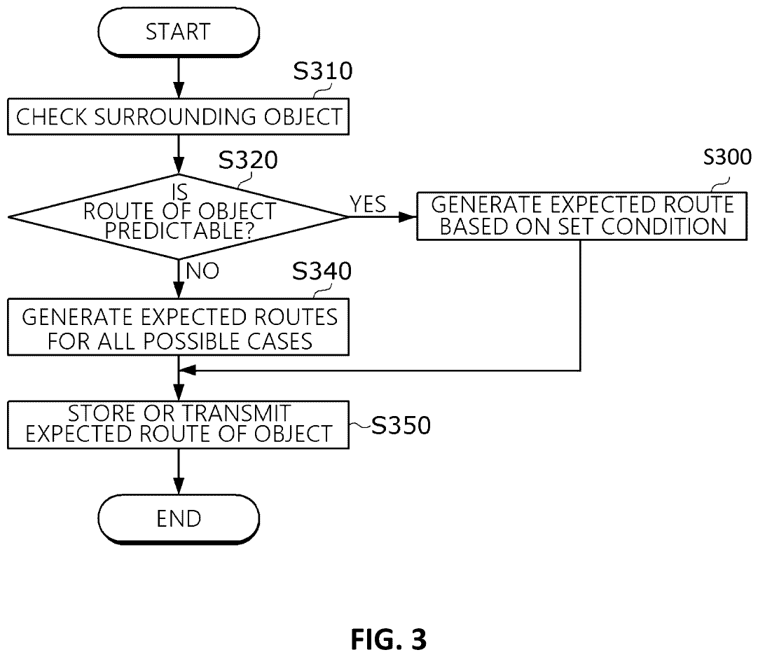

FIG. 3 is a flowchart of operations of generating an expected route of a surrounding object according to the embodiment. The contents of FIG. 3 show specific contents of operation S210 in FIG. 2 described above, and any description overlapping with FIG. 2 may be omitted.

The processor 130 may check a surrounding object (S310) and determine whether a route of the checked surrounding object is a predictable route (S320).

Specifically, the processor 130 may check information that may predict the route of the object. The processor 130 may directly check information about the object through the sensor unit 150, or collect information that may predict the route of the object from the corresponding object or an external server through the communication unit 110. For example, the processor 130 may check motion information (e.g., a location, a heading angle, a speed, an acceleration, and the like) about the object and turn signal information (e.g., turn signal). For example, the processor 130 may check map information (e.g., lane information, stop lines, crosswalks, and the like) and traffic signals (e.g., traffic light information).

The processor 130 may determine whether the route of the surrounding object is a predictable route based on the information checked as described above. The determination may be made using checked information using a preset database, a probability function, or processing of software trained based on deep learning, but is not limited thereto.

Unpredictable expected routes may include, for example, crossing pedestrians, vehicles passing through roundabouts, vehicles making unprotected left turns, or the like. That is, the unpredictable expected routes may be a scenario involving route selection situations that are difficult to expect using existing checked information, decisions that are difficult to predict, such as jaywalking, or the like.

When the route of the object is predictable (YES in S320), the processor 130 may generate the expected route of the object based on the set condition (S330). For example, the processor 130 may generate the expected route of the object based on motion information, map information, a turn signal, and other traffic signals.

As an example of generating the expected route based on the motion information, an expected route of a traveling vehicle may be generated in a form of maintaining a current heading angle, a speed, and an acceleration.

As an example of generating the expected route based on the map information, an expected route of a vehicle traveling on a last part of a merging lane may be generated in a form of entering the merging lane. In this case, the expected route may be generated even when the speed is not detected in a merging direction.

As an example of generating the expected route based on the turn signal, an expected route of a vehicle traveling with the turn signal turned on may be generated in a form of changing lanes in a corresponding direction. In this case, the expected route may be generated even when the speed in the direction of the turn signal is not detected.

As an example of generating the expected route based on the traffic signals, an expected route of a vehicle stopping at a red traffic light is generated in the direction the vehicle would proceed in a corresponding lane when the traffic light changes to green. In this case, the expected route may be generated even when the speed is not detected after the traffic light changes to green.

When the route of the object is unpredictable (NO in S320), the processor 130 may generate expected routes for all possible cases of the object (S340).

For example, as in the case of a jaywalking pedestrian, in a situation where it is difficult to predict whether the pedestrian will continue to move in a crossing direction, stop at a current location, or return in a direction toward where the pedestrian has come, the processor 130 may generate expected routes for all of a pedestrian who maintains current motion information, a pedestrian who is standing at a current location, and a pedestrian who returns to the route from which the pedestrian has come.

For example, in a situation where it is difficult to predict whether a vehicle traveling on a roundabout will continue to travel on the roundabout or exit onto an off-ramp (e.g., when traveling while reducing speed near the off-ramp), the processor 130 may maintain current motion information and generate expected routes for both a vehicle continuing to travel on the roundabout and a vehicle exiting onto the off-ramp.

For example, in a situation where it is difficult to predict at what point a vehicle waiting to make an unprotected left turn will execute the unprotected left turn, the processor 130 may generate both an expected route when the unprotected left turn is executed before a first opposing vehicle of the current waiting vehicle and an expected route when the unprotected left turn is executed after the first opposing vehicle is sent.

Next, the processor 130 may store the generated expected route of the object in the storage unit 120 or transmit the expected route to the outside through the communication unit 110.

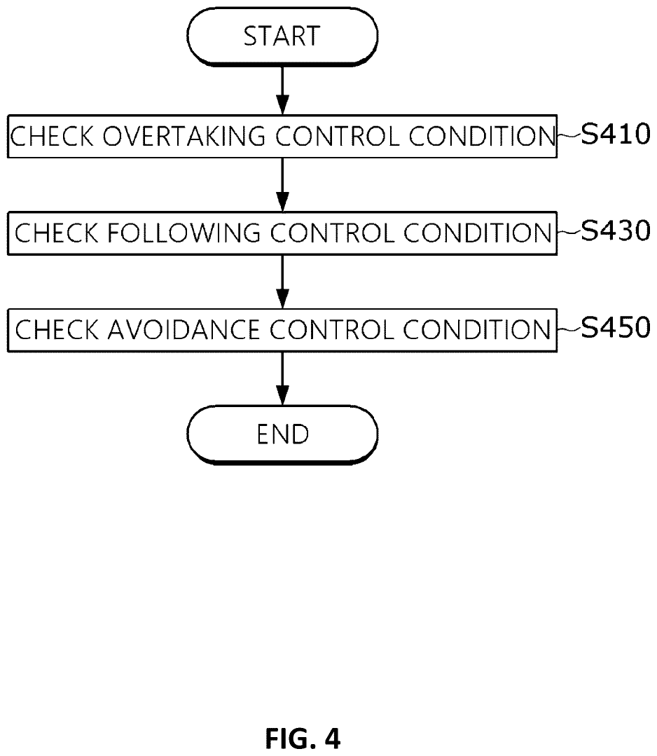

FIG. 4 is a flowchart of operations of determining a corresponding control condition of the vehicle according to the embodiment. The contents of FIG. 4 show specific contents of operation S230 in FIG. 2 described above, and any description overlapping with FIG. 2 may be omitted.

The processor 130 may set, generate, or check a driving control condition of a surrounding object.

The processor 130 may check an overtaking control condition (S410). For example, when an expected route of the surrounding object may be expected to enter a lane where the vehicle 1 is located and the vehicle 1 is allowed to travel in front of the object, the processor 130 may generate the overtaking control condition.

The overtaking control condition is, for example, that the object should not be currently positioned in front of the vehicle 1 on the lane where the vehicle 1 is located and that an entry position of the vehicle 1 according to the expected route of the surrounding object should be a position that the vehicle 1 may reach by accelerating.

The processor 130 may check a following control condition (S430). For example, when the surrounding object is already on the lane where the vehicle 1 is located or is expected to enter the lane of the vehicle 1 and the vehicle 1 is allowed to travel at the rear of the object, the processor 130 may generate the following control condition.

The following control condition is, for example, that the surrounding object should not be currently positioned at the rear of the vehicle 1 on the lane where the vehicle 1 is located and that the entry position of the surrounding object into the lane where the vehicle is located according to the expected route should not be currently positioned at the rear of the vehicle 1.

The processor 130 may check an avoidance control condition (S450). For example, when the surrounding object is expected to enter the lane where the vehicle 1 is located based on the expected route of the object and the vehicle 1 is allowed to travel while avoiding the object, the processor 130 may generate the avoidance control condition.

The avoidance control condition may refer to, for example, a case where there is a margin of time or space from a time the surrounding object enters the lane where the vehicle 1 is located to a time the surrounding object occupies the lane. For example, the avoidance control condition may refer to a case where, when the corresponding object at least partially enters the lane where the vehicle 1 is located, a time taken for a vertical distance between the object and an opposite lane to be secured by a predetermined distance (e.g., 2.6 m) or longer is secured by a predetermined time (e.g., 2 seconds) or longer.

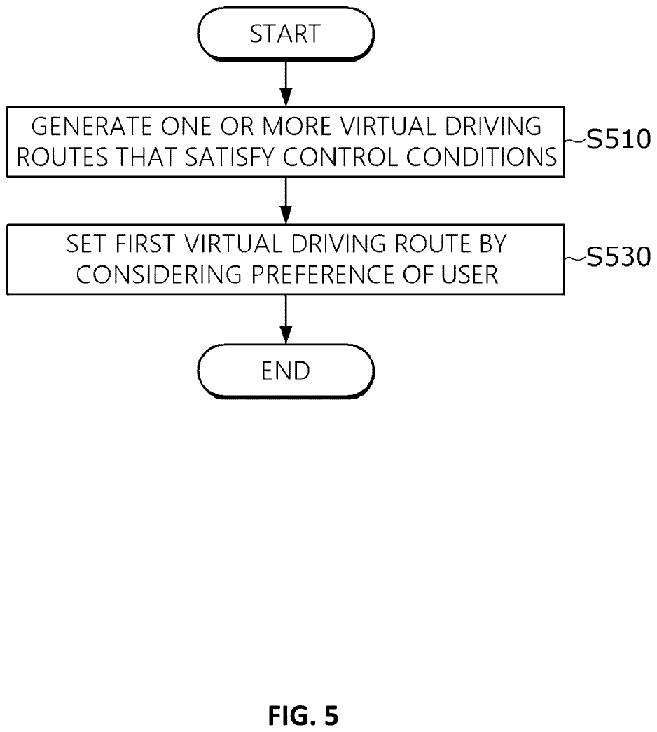

FIG. 5 is a flowchart of operations of setting a first virtual driving route according to the embodiment.

The processor 130 may generate control flows that satisfy driving control conditions for all surrounding objects of the vehicle 1, that is, virtual driving routes (S510). In addition, the processor 130 may select a first virtual driving route, which is an optimal virtual driving route, by considering the user preference among the generated virtual driving routes (S530).

Specifically, the processor 130 may generate virtual driving routes that satisfy at least one of the driving control conditions. The generated virtual driving routes may first be classified into candidate driving routes.

For example, as various candidate driving routes, a virtual driving route that continuously accelerates at 2 m/s2 from 0 to 5 seconds based on a current time point, a virtual driving route that accelerates at −2 m/s2 from 0 to 4 seconds, and −1 m/s2 from 4 to 5 seconds, and the like, may be set.

Next, the processor 130 may extract one or more candidate driving routes that satisfy all driving control conditions corresponding to all surrounding objects among the generated candidate driving routes.

For example, in FIG. 8, when the vehicle 1 has the avoidance control condition and the overtaking control condition set for the first object C1 and only the following control condition set for the second object C2, the processor 130 may select two candidate driving routes as executable candidate driving routes. That is, the processor 130 may select a candidate driving route that avoids the first object C1 and follows the second object C2 among the candidate driving routes and a candidate driving route that overtakes the first object C1 and follows the second object C2 as executable candidate driving routes.

According to one embodiment, the processor 130 may delete remaining candidate driving routes except for the executable candidate driving routes among the candidate driving routes.

Next, the processor 130 may set an optimal candidate driving route among the executable candidate driving routes as the first virtual driving route by considering the user preference.

For example, the processor 130 may calculate scoring for the executable candidate driving routes. The scoring may be calculated based on the user preference. That is, the scoring may be a value obtained by evaluating the degree to which the user prefers the executable candidate driving routes.

For example, for a driver having the highest preference for a maximum travel distance, a route having the longest distance among the executable candidate driving routes may be set as the first virtual driving route.

For example, for a driver who places the highest value on ride comfort, a route having a maximum deceleration and the smallest change in deceleration among the executable candidate driving routes may be set as the first virtual driving route.

Settings based on the user preference as described above may be performed by the user at any time point or may be automatically collected by the system of the vehicle 1. For example, the processor 130 may map accumulated autonomous driving selection inputs of a specific driver to items related to a specific preference to create a database, and may calculate scoring for routes based on the contents of the created database. However, without being limited thereto, scoring may be calculated to have a specific preference for each driver through deep learning-based learning.

According to one embodiment, the processor 130 may generate a second virtual driving route.

The second virtual driving route may be at least one of routes among the executable candidate driving routes, excluding the first virtual driving route. For example, the second virtual driving route may be a route having the highest scoring related to the user preference after the first virtual driving route among the executable candidate driving routes. However, without being limited thereto, any arbitrary route may be set as the second virtual driving route depending on user settings and a road driving environment.

For example, the route P2 in FIG. 9 may be set as the second virtual driving route. In this case, the vehicle 1 may set a route for avoiding the first object C1 and following the second object C2 as the first virtual driving route as the optimal route, and may set a route for reducing the speed and following the first object C1 as the second virtual driving route as the candidate route.

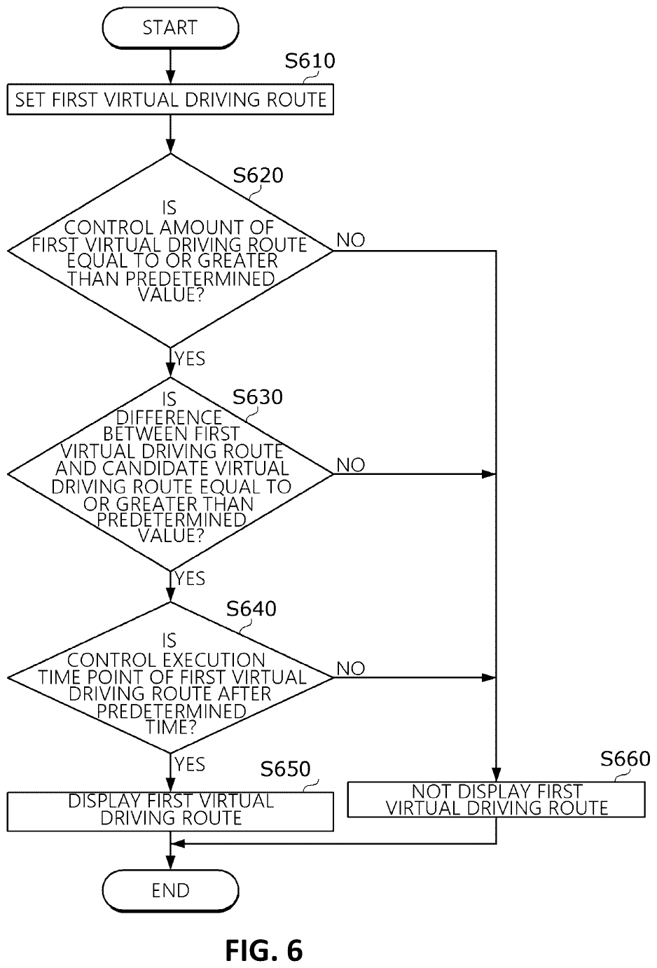

FIG. 6 is a flowchart of operations of determining display of the first virtual driving route according to the embodiment. Any description of the contents of FIG. 6 that overlaps with those of FIGS. 1 to 5 may be omitted.

The processor 130 may set a first virtual driving route as described above (S610). In addition, in the process of setting the first virtual driving route, executable candidate driving routes may be generated, and a second virtual driving route different from the first virtual driving route may be generated among the executable candidate driving routes.

The processor 130 may determine whether a control amount of the first virtual driving route is equal to or greater than a predetermined value (S620).

The control amount of the first virtual driving route may include elements such as lateral/longitudinal speed and acceleration, a location, a yaw rate, a heading angle of the vehicle, and the like, for moving the vehicle 1 along the first virtual driving route, but is not limited thereto.

When the control amount of the first virtual driving route is not the predetermined value or more (NO in S620), the first virtual driving route is not displayed (S660). For example, when the longitudinal acceleration used in the first virtual driving route is less than 2 m/s² and the lateral acceleration is less than 1 m/s², the first virtual driving route may not be displayed on the display and the existing displayed screen may be maintained. This is because, when the driving route involves subtle controls, there is less need to make the driver aware in advance.

When the control amount of the first virtual driving route is equal to or greater than the predetermined value (YES in S620), the processor 130 may determine whether a difference between the first virtual driving route and a candidate virtual driving route is equal to or greater than a predetermined value (S630). When the difference between the first virtual driving route and the candidate virtual driving route is less than the predetermined value (NO in S630), the first virtual driving route is not displayed (S660). The candidate virtual driving route may be, for example, the second virtual driving route, but is not limited thereto and may also be another candidate driving route.

For example, when a difference in longitudinal acceleration between the first virtual driving route and the second virtual driving route is within 2 m/s², and a difference in lateral acceleration between the first virtual driving route and the second virtual driving route is within 1 m/s², the first virtual driving route may not be displayed on the display, and the existing displayed screen may be maintained.

When the difference between the first virtual driving route and the candidate virtual driving route is equal to or greater than the predetermined value (YES in S630), the processor 130 may check whether a control execution time point of the first virtual driving route is after a predetermined time based on a current determination time point (S640).

Specifically, when determining whether to display the first virtual driving route, the processor 130 may check the control execution time point corresponding to the first virtual driving route. The control execution time point may be calculated when setting the driving control condition. The first virtual driving route should be displayed in advance so that the driver may check the first virtual driving route and make predictions, but there may be cases where the time itself is not secured.

Therefore, when the control execution time point of the first virtual driving route is not after the predetermined time based on the current determination time point (NO in S640), that is, when a sufficient time to display the first virtual driving route is not secured, the first virtual driving route may not be displayed (S660) and the existing displayed screen may be maintained.

When the control execution time of the first virtual driving route is after the predetermined time based on the current determination time point (YES in S640), that is, when the sufficient time to display the first virtual driving route is secured, the processor 130 may display the first virtual driving route through the display.

In FIG. 6, the processor 130 is illustrated as displaying the first virtual driving route only when “YES” is selected in all of operations S620, S630, and S640, but is not limited thereto. For example, the processor 130 may display the first virtual driving route through the display even when only at least one of operations S620, S630, and S640 is selected as “YES.”.

In addition, the conditions related to the display in FIG. 6 may be partially excepted depending on user selection or combined with user selection. For example, in the process of determining whether the difference between the first virtual driving route and the candidate virtual driving route is equal to or greater than the predetermined value (S630), when a time point at which the difference is determined to be equal to or greater than the predetermined value is equal to or greater than a predetermined time (e.g., 10 seconds), the processor 130 may request the user whether to display the first virtual driving route and may determine whether to display the first virtual driving route according to user input.

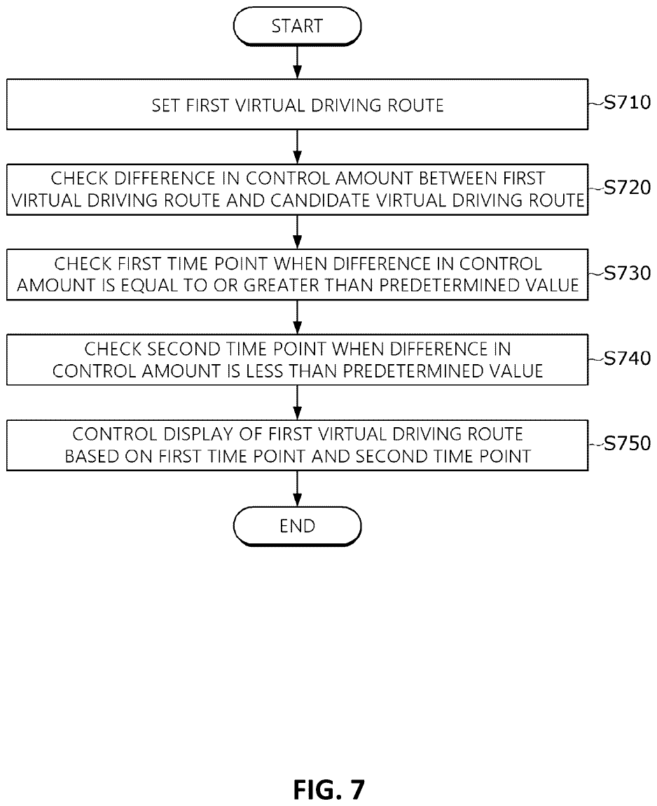

FIG. 7 is a flowchart of operations of determining display of a first virtual driving route according to another embodiment. FIG. 7 illustrates the contents of displaying the first virtual driving route based on a difference between a control amount of the first virtual driving route and a control amount of a candidate virtual driving route (e.g., a second virtual driving route). The contents in FIG. 7 that overlaps with the contents of FIGS. 2 to 6 may be omitted.

The processor 130 may set a first virtual driving route (S710). In addition, in the process of setting the first virtual driving route, executable candidate driving routes may be generated, and a second virtual driving route different from the first virtual driving route may be generated among the executable candidate driving routes.

The processor 130 may check a difference in control amount between the first virtual driving route and a candidate virtual driving route (e.g., the second virtual driving route) (S720).

For example, the processor 130 may check the difference between a control amount corresponding to the first virtual driving route and a control amount corresponding to at least one of a plurality of virtual driving routes that satisfy the driving control condition of the vehicle.

The processor 130 may check a first time point at which the difference in control amount between the first virtual driving route and the candidate virtual driving route is equal to or greater than a predetermined value (S730). The predetermined value may be set in advance.

In addition, the processor 130 may check a second time point at which the difference in control amount between the first virtual driving route and the candidate virtual driving route is less than a predetermined value (S740).

The processor 130 may control display of a virtual driving route based on the first time point and the second time point (S750). For example, the processor 130 may control a display to display the first virtual driving route through the input/output interface 140 from the first time point or a predetermined time (e.g., 1 second) before the first time point. In addition, the processor 130 may control the display to end the display of the first virtual driving route from the second time point. According to one embodiment, the second time point may be after the first time point.

Meanwhile, according to one embodiment, the processor 130 may control a display to display contents related to a current situation through the input/output interface 140. In addition, at least one of an expected route of a surrounding object and the virtual driving route of the vehicle 1 may be displayed to be distinguished from the contents related to the current situation. The contents related to the current situation may include a location, a speed, a direction of the currently driving vehicle 1, and the like, but are not limited thereto. For example, as illustrated in FIG. 9, when the first object C1 is defined as the contents related to the current situation, the first object C1 and the virtual objects C1_c, C1_b, and C1_c may be displayed with different colors or the like.

According to one embodiment, the processor 130 may reflect and display the driver's selection among several virtual driving routes. For example, the processor 130 may adjust a weight value through user settings or the like to reflect the driver's tendencies in selecting the virtual driving route.

In FIG. 11, a screen in which the second virtual driving route is displayed through the display is illustrated. The second virtual driving route of the vehicle 1 may be displayed through at least one virtual object 1_e or 1_f.

The first virtual driving route and the second virtual driving route of the vehicle 1 are illustrated as being separately displayed through FIGS. 10 and 11, but according to one embodiment, the first virtual driving route and the second virtual driving route of the vehicle 1 may be displayed together on one screen. In this case, the first virtual driving route and the second virtual driving route may be displayed to be distinguished from each other. For example, the second virtual driving route may be set to have lower brightness or saturation than the first virtual driving route. For example, the first virtual driving route and the second virtual driving route may be displayed with different colors.

In addition, the second virtual driving route may be additionally displayed depending on the selection of the user. For example, while the first virtual driving route is being displayed, the processor 130 may receive a user input requesting display of the second virtual driving route through the display, and may additionally display the second virtual driving route in response to the user input.

Through the above-described embodiments, the vehicle system may show the user which situation the control flows, that is, the virtual driving routes, are selected based on, thereby making it possible to increase the user's reliability of the control of the vehicle system.

The term “unit” used in the present embodiment refers to software component or hardware components such as a field-programmable gate array (FPGA) or an application specific integrated circuit (ASIC), and “unit” performs certain functions. However, the “˜unit” is not limited to software or hardware. The “˜unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “unit” may be coupled with lesser numbers of components and “units,” or may be further divided into additional components and “units.” Furthermore, the components and “˜units” may be implemented to reproduce one or more CPUs in a device or a security multimedia card.

According to an embodiment of the present disclosure, by displaying a virtual driving route of a vehicle based on an expected route for a surrounding object and a driving control condition of a host vehicle, a user can intuitively check when and what type of vehicle driving control is performed. Thereby, the user can build high trust in an autonomous driving system of the vehicle.

Effects of the present disclosure are not limited to those mentioned above, and other effects not mentioned will be clearly understood by those of ordinary skill in the art from the description below.

Although the preferred embodiments of the present disclosure have been described above, it is understood that those skilled in the art can make various changes and modifications to the present disclosure without departing from the spirit and scope of the present disclosure set forth in the claims below.

What is claimed is:

1. A control device comprising:
a display; and
a processor configured to generate an expected route for at least one object around a vehicle, set a driving control condition of the vehicle corresponding to the expected route, and control the display to display at least one of a virtual driving route satisfying the driving control condition of the vehicle and the expected route of the object.

2. The control device of claim 1, wherein the processor is configured to select a first virtual driving route among a plurality of virtual driving routes that satisfy the driving control condition of the vehicle and control the display to display the selected first virtual driving route.

3. The control device of claim 2, wherein the processor is configured to control the display to display a second virtual driving route excluding the first virtual driving route among the plurality of virtual driving routes, through the display.

4. The control device of claim 3, wherein the processor is configured to control the display to display the first virtual driving route and the second virtual driving route to be distinguished from each other.

5. The control device of claim 2, wherein the processor is configured to control the display to display the first virtual driving route based on that a control amount corresponding to the first virtual driving route differs from a control amount corresponding to at least one of the plurality of virtual driving routes by a predetermined value or more.

6. The control device of claim 1, wherein the processor is configured to control the display to display the virtual driving route based on that a control execution time point corresponding to the virtual driving route is after a predetermined time from a current time point.

7. The control device of claim 1, wherein the processor is configured to control the display to display the virtual driving route based on any one of the following cases including that:
a longitudinal control amount corresponding to the virtual driving route is equal to or greater than a predetermined value; and
a lateral control amount corresponding to the virtual driving route is equal to or greater than a predetermined value.

8. The control device of claim 1, wherein the processor is configured to:
control the display to display the first virtual driving route based on a time point at which a difference between a control amount corresponding to the first virtual driving route and a control amount corresponding to at least one of the plurality of virtual driving routes satisfying the driving control condition of the vehicle reaches or exceeds a predetermined value; and
control the display to end the display of the first virtual driving route based on that the difference between the control amounts is less than the predetermined value.

9. The control device of claim 2, wherein the processor is configured to select the first virtual driving route based on a preference of a vehicle user.

10. The control device of claim 1, wherein the processor is configured to:
control the display to further display contents related to a current situation through the display; and
control the display to display at least one of the expected route of the surrounding object and the virtual driving route of the vehicle to be distinguished from the contents related to the current situation.

11. A method of displaying a driving route of a vehicle including a display, comprising:
generating an expected route for at least one object around the vehicle;
setting a driving control condition of the vehicle corresponding to the expected route; and
controlling the display to display at least one of a virtual driving route satisfying the driving control condition of the vehicle and the expected route of the object through the display.

12. The method of claim 11, further comprising:
selecting a first virtual driving route among a plurality of virtual driving routes that satisfy the driving control condition of the vehicle; and
controlling the display to display the selected first virtual driving route through the display.

13. The method of claim 12, further comprising further controlling the display to display a second virtual driving route excluding the first virtual driving route among the plurality of virtual driving routes.

14. The method of claim 13, wherein the first virtual driving route and the second virtual driving route are displayed to be distinguished from each other.

15. The method of claim 12, wherein the first virtual driving route is displayed based on that a control amount corresponding to the first virtual driving route differs from a control amount corresponding to at least one of the plurality of virtual driving routes by a predetermined value or more.

16. The method of claim 11, wherein the virtual driving route is displayed based on that a control execution time point corresponding to the virtual driving route is after a predetermined time from a current time point.

17. The method of claim 11, wherein the virtual driving route is displayed based on any of the following cases including that:
a longitudinal control amount corresponding to the virtual driving route is equal to or greater than a predetermined value; and
a lateral control amount corresponding to the virtual driving route is equal to or greater than a predetermined value.

18. The method of claim 11, wherein the first virtual driving route is displayed based on a time point at which a difference between a control amount corresponding to the first virtual driving route and a control amount corresponding to at least one of the plurality of virtual driving routes satisfying the driving control condition of the vehicle reaches or exceeds a predetermined value, and
the display of the first virtual driving route is ended based on that the difference between the control amounts is less than the predetermined value.

19. The method of claim 12, wherein in the selecting of the first virtual driving route, the first virtual driving route is selected based on a preference of a vehicle user.

20. The method of claim 11, further comprising controlling the display to display contents related to a current situation through the display,
wherein at least one of the expected route of the surrounding object and the virtual driving route of the vehicle is displayed to be distinguished from the contents related to the current situation.
